(19) United States
(12) Patent Application Publication
(10) Pub. No.: US 2003/0189314 A1
(43) Pub. Date: Oct. 9, 2003

(54) Non-metallic edge gliding board

(76) Inventors: Johnny S. Quattro, San Clemente, CA (US); Jared Eberhardt, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/118,638

(22) Filed: Apr. 8, 2002

(51) Int. Cl. B62B 9/04

(52) U.S. Cl. 280/602; 280/14.22

(57) ABSTRACT

An improved snowboard is provided in accordance with the present invention. The board comprises a soft edge for improved sliding over hard surfaces. The board does not have metallic edges. A method of riding an improved freestyle snowboard is also provided.

### BACKGROUND OF THE INVENTION

1. Field of the Invention

The present invention relates to a gliding board, and in particular, a snowboard for gliding on non-snow surfaces.

2. Description of the Related Art

Snowboarding is a relatively new sport which can be compared to skateboarding or surfing, on snow. To snowboard, the rider stands on a board with his/her left or right foot forward, facing one side of the board. The feet are attached to the board via bindings.

Snowboarding has gained in popularity only during the last 15 years. It was pioneered in the late 1970's by a small group of individuals with credit typically going to Jake Burton and Tom Sims. The roots, however, started with the “snurfer” which was a sledding toy shaped like a small water ski, with rope tied to the back where the user stood. Burton was involved with snurfer racing and was the first to put a retention device on his boards.

Snowboarding is now prevalent on virtually all downhill ski slopes worldwide. In 1985 only 7 percent of ski areas allowed snowboards; today more than 90 percent allow snowboards, and over half have specialized snowboard areas referred to as half pipes and terrain parks. A half pipe is a trough cut or built up with snow, with the term originating from skateboarding. Terrain parks include skatepark-like obstacles such as handrails, ledges, jumps, and slide bars. Today about 10 percent of the world skier population comprises snowboarders, with the annual growth rate for the sport projected at 20 percent. In the United States, about 80 percent of snowboarders are male with an average age of 20.8 years. The average snowboarder rides 15 days a year, which is 3 times that of the average skier.

FIGS. 1A-B show plan and cross-sectional views of the construction of typical snowboards. Typical snowboards include a central core 10 surrounded by a shell 12, which is generally a sturdy material. The board is further characterized by a base 14 which allows the board to glide along the riding surface. A steel edge 18 is also provided to avoid excessive slipping on snow. These snowboards also typically require both feet to be mounted to the board during riding.

As snowboarding has evolved, the sport has divided into a number of different areas: downhill racing, slalom, GS, Super G, alpine, and freestyle, among others. Freestyle riders generally use mounds of snow, snowboard half-pipes, ledges, or other structures to launch into the air and perform a number of tricks. These freestyle riders also typically use the boards to slide along structures or obstacles. These structures are similar to those found in traditional skateparks, frequented by skateboarders. Many of these skateboarders are also snowboarders, and desire to perform the same tricks during the winter months. This style of riding is generally referred to as jibbing, which includes riding hard or rough surfaces, such as wood, metal, and concrete, which are destructive to traditional snowboards.

Present snowboards do not provide the flexibility required for these activities. In addition, the metal edges on snowboards act as contact points for the board, and produce undesirable friction and catching. Thus, a snowboard is required that has the characteristics and feel of a typical snowboard, yet provides improved performance for freestyle riding.

### SUMMARY OF THE INVENTION

An improved snowboard for freestyle riding is provided in accordance with the present invention. An improved method of riding a snowboard on a gliding surface is also provided.

The snowboard of the present invention generally comprises a core, a running surface, a gliding surface, and a non-metallic edge. The board does not include metal edges, reducing friction and catching while gliding on surfaces. Furthermore, the board has less sidecut because it is not meant to be turned at high speed. The board is generally more flexible and lighter than the traditional board, which causes it to be more maneuverable.

The method of the present invention involves sliding the non-metallic edge over a non-traditional snowboarding surface or obstacle. The obstacles include those traditionally found at skateparks and other similar obstacles, such as hand rails, benches, stairs, cement ledges, picnic tables, curbs, rocks, soccer goal posts, cars and logs. A number of additional freestyle riding activities may be performed with the present invention, such rail slides, nose presses, 50/50s, lipslides, etc.

### BRIEF DESCRIPTION OF THE DRAWINGS

FIG. 1A is a top view showing a snowboard of the prior art.

FIG. 1B is a cross-sectional view showing the prior art snowboard of FIG. 1A.

FIG. 2 is a top view of the snowboard of the present invention.

FIG. 3 is a side view showing the snowboard of FIG. 2.

FIG. 4 is a cross-sectional view of the snowboard of FIG. 2.

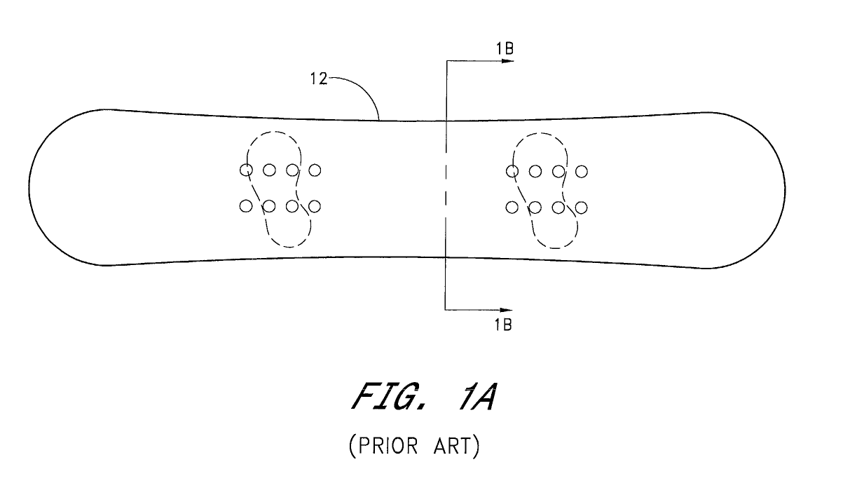

### DETAILED DESCRIPTION OF THE PREFERRED EMBODIMENT

The following detailed description presents various specific embodiments of the present invention. However, the present invention can be embodied in a multitude of different forms as defined and covered by the claims. In this description, reference is made to the drawings wherein like parts are designated with like numerals throughout.

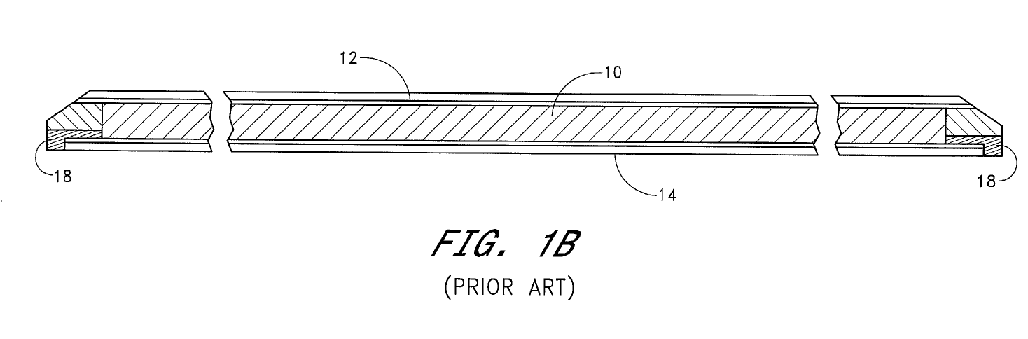

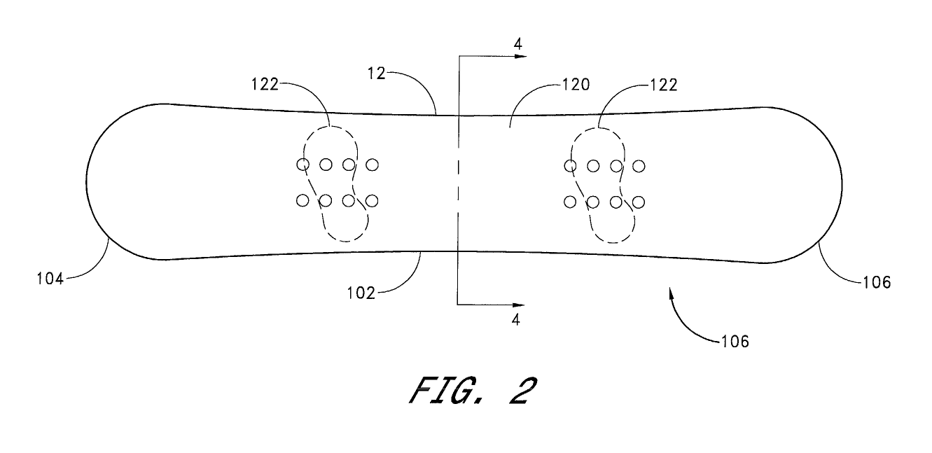

With reference to FIG. 2, the present invention comprises a riding apparatus 100, which preferably comprises a snowboard. In the embodiment shown in FIGS. 2-4, the riding apparatus 100 comprises a snowboard. In a preferred embodiment, such a snowboard is an elongate structure, approximately 5 feet in length, having an elongate body 102 with a front end 104 and a rear end 106. The board is preferably at least 4 feet in length, and is generally about 1 foot wide. The board is also preferably symmetrical as shown in FIG. 2; however, it will be appreciated that the board may also be asymmetrical. The board typically curves up at each end 104, 106, providing improved steerability. See FIG. 3.

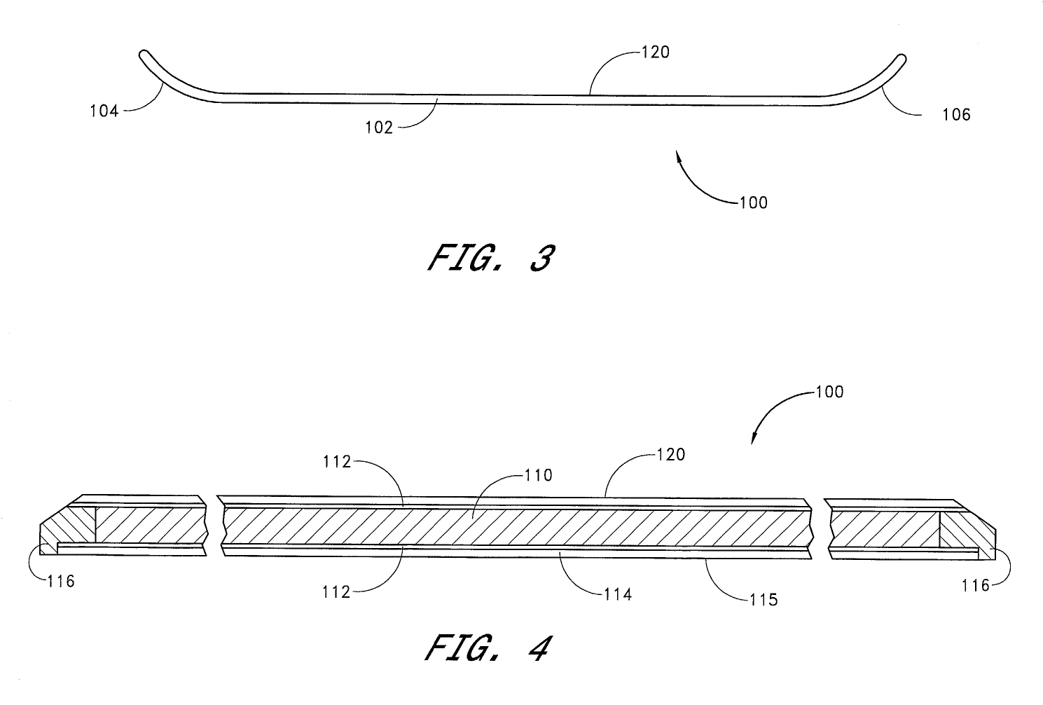

The riding apparatus is preferably constructed from a central core 110, as shown in FIG. 4. The core is typically formed of wood, foam, or a composite material. Surrounding this core is a shell 112, which preferably comprises a sturdy and durable material such as molded polyethylene or fiberglass. This material may also comprise a composite material. The board also comprises a base 114. The material forming the base 114 of the riding apparatus allows the board to glide along the surface, which may include snow. Base 114 forms a gliding surface 115. The materials that form shell 112 and base 114 should be sufficiently lightweight to allow the board to be manually transportable by the rider to the area of use, and may include molded polyethylene, fiberglass, or composite materials.

The board preferably comprises a non-catching edge which forms the side wall 116 of the board. Non-catching, as used herein, means an edge made of a material which is softer than the material over which the edge is intended to glide. The non-catching edge will not catch on the hard, irregular sliding surfaces. In addition, a non-catching side wall does not include a metal edge, and is therefore also non-metallic. The side wall 116 preferably is formed of a plastic such as acrylonitrile-butadiene-styrene (ABS). Other suitable materials may form side wall 116. The material should be reasonably abrasion-resistant, but relatively slick to provide the best running control conditions. The side wall 116 also preferably extends around the entire length of the board. However, it also envisioned that the side wall 116 extends only along the sides, and not the front and back of the board. The side wall 116 is also preferably chamfered or similarly angled.

The non-catching side wall 116 provides an improved sliding surface for the board. Typical snowboards include metal edges, which tend to cause friction or catch when sliding on hard surfaces, such as rails, stairs, and benches. The non-catching side wall 116 not only reduces the friction and eliminates the catching, but also provides an additional gliding surface. Accordingly, the board comprises a plurality of gliding surfaces.

The riding apparatus 100 preferably is characterized by a flat or slightly concave rider support surface 120, which preferably is of sufficient size to permit a rider to stand on the rider support surface 120 with both feet. When the rider stands on the body 102, it tends to flatten out. When the rider is jumping or otherwise not in contact with the snow or other surface on which he is riding, or only in light contact with it, the board reverts to its cambered shape, so as to improve steerability at the moment of initial contact with the snow surface.

The riding apparatus 100 of the present invention has no metal edges. In addition, the riding apparatus of the present invention does not require the stiffness and dampening properties of a typical snowboard. In traditional snowboards, vibration damping materials like rubber may be provided in the nose and tail, and sometimes between the side wall and edge. Consequently, the board may be constructed to be lighter and more flexible than the conventional board, since these additional materials are not necessary. However, the board has similar riding properties as a typical snowboard.

The board has a conventional construction, preferably a sandwich type structure, as known to those of skill in the art. The riding apparatus 100 is completed using conventional molding techniques, by layering the base 114, the core 110, the side walls 116, and the shell 112 within a mold. The assembled layers are then molded between upper and lower mold halves, applying heat and pressure to shape and adhere the layers together in accordance with conventional molding techniques.

Bindings 122 may also be provided for securing a rider to the board. The bindings 122 are attached to the board using any desired technique as known to those of skill in the art. Holes may simply be drilled into the board, or a slider system or inserts may be incorporated into the board. However, in another preferred embodiment, the board is ridden without bindings. In this case, the board may also be provided with a non-skid surface, such as rubber, to provide an improved gripping surface.

In the present invention, it is envisioned that the board is to be glided by advancing the base over a hard surface. The base is a non-catching gliding surface. The side edges no longer catch on the hard surface due to the non-metallic edges. It is also envisioned that the side edges can be used as a gliding surface as well. The board is not intended primarily for-riding on snow, as with traditional snowboards, but rather for non-traditional gliding surfaces which are harder than the non-catching edges. Thus, the board will be used for riding over surfaces or obstacles such as rails, stairs, benches, cement ledges, picnic tables, curbs, rocks, soccer goal posts, cars, logs and other similar non-traditional snowboarding or gliding surfaces. These obstacles preferably have a generally slick surface. This style of riding is traditionally known as jibbing.

The snowboard may also be ridden similar to present day skateboards, wherein the rider may perform a number of well known tricks, such as rail slides, nose presses, 50/50s, lipslides, etc.

Although the present invention has been described in terms of certain preferred embodiments, other embodiments of the invention including variations in dimensions, configuration and materials will be apparent to those of skill in the art in view of the disclosure herein. In addition, all features discussed in connection with any one embodiment herein can be readily adapted for use in other embodiments herein. The use of different terms or reference numerals for similar features in different embodiments does not imply differences other than those which are expressly set forth. Accordingly, the present invention is intended to be defined solely by reference to the appended claims, and not limited to the preferred embodiments disclosed herein.

What is claimed is:

1. A gliding board, comprising:
a core;
a rider support surface;
a gliding surface; and
a non-metallic edge in contact with said core, rider support surface and gliding surface.

2. The board of claim 1, wherein said non-metallic edge comprises ABS.

3. The board of claim 1, further comprising bindings for attaching a rider to said board.

4. The board of claim 1, wherein said core comprises materials selected from the group consisting of foam, wood, composite materials, and combinations thereof.

5. A gliding board, comprising:
a core;
a rider support surface;
a gliding surface; and
a side edge made of ABS, in contact with said core, said rider support surface, and said gliding surface,
wherein said board does not comprise metal edges.

6. A gliding board, comprising:
a board having an elongate surface and a non-metallic edge,
wherein said board has a length of at least about 4 feet, and a width of about 1 foot.

7. A method of gliding a board, comprising:
gliding a board on a non-snow surface by advancing a non-metallic surface over obstacles, wherein said board comprises an ABS edge.

8. A method of using a snowboard to slide on obstacles:
gliding a board on a hard surface by advancing a non-catching gliding surface over said hard surface.

9. A method of gliding a board on a hard surface comprising:
advancing a non-catching gliding surface over the hard surface.

10. A method of gliding a board on a hard surface comprising:
providing a board having a gliding surface and an ABS edge;
sliding said gliding surface on the hard surface.

11. The method of claim 10, wherein said hard surface is selected from the group consisting of rails, benches, ledges, picnic tables, curbs, rocks, soccer goal posts, cars, logs, and stairs.

12. A gliding board, comprising:
a primary gliding surface;
a pair of secondary binding surfaces bordering said primary gliding surface, said secondary gliding surfaces being softer than said primary gliding surface.

13. The gliding board of claim 12, wherein said pair of secondary gliding surfaces comprises ABS.

14. A gliding board, comprising:
a core;
a rider support surface;
a gliding surface; and
a non-catching edge in contact with said core, rider support surface and gliding surface.

15. A method of gliding a board on a surface comprising:
advancing an edge over a surface, wherein the edge is softer than the surface.
